(19) United States
(12) Patent Application Publication
(10) Pub. No.: US 2015/0073878 A1
(43) Pub. Date: Mar. 12, 2015

(54) DEVICE TO PERFORM SERVICE CONTRACT ANALYSIS

(71) Applicant: Robert F. Sheppard, Telford Shropshire (GB)

(72) Inventor: Robert F. Sheppard, Telford Shropshire (GB)

(21) Appl. No.: 14/395,437

(22) PCT Filed: Jul. 30, 2012
(86) PCT No.: PCT/US2012/048776

§ 371 Date: Oct. 17, 2014

(51) Int. Cl. G06Q 10/06

(52) U.S. Cl. CPC G06Q 10/06395
USPC 705/7.41

(57) ABSTRACT

A device to perform service contract analysis comprises a processor; and a memory, wherein the memory comprises instructions, the processor to perform the instructions to cause the device to operate to: receive data indicating performance levels of business processes subject to a service contract, the data including a plurality of records, each record including performance data, and each record associated with a business process; compare the performance data with a threshold derived from the service contract; determine a financial outcome based on the comparing; and associate contributions of the financial outcome with respective records or respective service processes, wherein the contributions are based on the comparing.

### BACKGROUND

Service Level Agreements (SLAs) dictate that the quality of service and/or the quality of experience, must be measured against the quality of expectation, for every facet of Service Delivery. Depending on the terms of the SLA, failure to meet any service level target may lead to penalties for the service provider, while exceeding service level targets may attract a bonus payment. Accordingly, each time a service delivery process is executed, it will be measured by one or more of these performance targets, to establish how many of the service delivery processes met the service level target (conformance) and how many did not (non-conformance). For example, a quality of service may be defined in terms of a maximum percentage of non-conformant cases in a defined time period.

Service level targets, which may define both performance expectation and quality expectation, may be defined in an agreement. Such agreements may be complex and varied, requiring collection and analysis of a significant amount of data relating to the provision of the service in order to evaluate compliance or otherwise with the service level target. The data to be collected and the analysis to be performed may be complicated.

Thus, it is necessary for many businesses to monitor, assess and report on compliance with Service level Agreements, Operating Level Agreements and Underpinning Contracts, etc. including the accounting of related revenue or liabilities incurred. This task may be particularly complex given the nature of commerce, contractual disparity, and the need to better understand where liabilities can be minimized and revenue maximized.

### BRIEF DESCRIPTION OF THE DRAWINGS

Examples of the invention are further described hereinafter with reference to the accompanying drawings, in which:

FIG. 1 shows a record according to an example.

FIG. 2 shows an example of a timeline according to an example.

FIG. 3 shows a process flow according to an example.

FIG. 4 shows a method according to an example.

FIG. 5 shows a method according to an example.

FIG. 6 shows a processing device according to an example.

FIG. 7 shows a processing system according to an example.

### DETAILED DESCRIPTION

Current techniques for the management of Service Contracts and Service Provision, involve a number of disconnected systems, tools and manual methods, which require the checking of data from multiple data sources, against multiple disparate contracts.

Various different metrics and measures may be used to determining whether service level targets have been met, with the result that the performance data required for evaluating performance may vary considerably between SLOs. This leads to data structures for capturing the performance data has been defined on a case-by-case basis for each SLO. Such data structures may be represented by a record having a plurality of fields, including at least one field for each of the performance data that must be collected to evaluate compliance or otherwise with the term or clause.

According to an example, each service delivery process falling within the scope of an SLA is broken down into one or more processes that are to be performed during the service delivery, with each process having one or more records associated therewith, such that each performance of the process results in the generation of one or more records. The records are collected in a database, and each record has the same fixed, pre-determined structure, independent of the SLA and process to which the record relates. The accumulated data in the records is sufficient to evaluate compliance or otherwise of that process with any relevant SLOs. In some examples, evaluation of performance may be based on an aggregation of the records associated with one or more relevant service processes.

This use of a commonly prescribed and consistent data structure greatly simplifies data entry and analysis, allowing a “like-for-like” comparison of records across disparate agreements, business processes, etc.

In some examples, each record includes data indicative of exactly two performance data elements. These may include one duration element and one volume element. For example, a duration element may represent a server up-time, a time to respond to an engineer callout, etc. The volume element is indicative of an amount of effort expended during the duration represented by the duration element. For example, the volume could represent a number of engineers attending a site, a number of visits necessary, or a number of advisors to which a query was routed before reaching an advisor able to respond to the query.

In some examples, the duration is represented by two fields of the record, representing a start and end time of the duration, e.g. using time and date stamps. In some cases, the start and end times of the period may be significant. For example, a service contract might not provide support during weekends, and in such a case, if a fault is reported on Saturday, the duration for the purposes of evaluating response time would not begin until Monday morning. Similar considerations may apply, for example, where there is a public holiday in the location of the service entity, etc.

The use of multiple records to audit a service delivery process leads to flexibility. For example, where events outside the control of the service provider extend a response time or other duration, the SLO may permit delays due to such disruptions to be discounted from the response time for the purposes of evaluating performance. According to the present example, a record may be added specifying the start and end time of the disruption, and the duration derived therefrom may be subtracted from the duration of the response time.

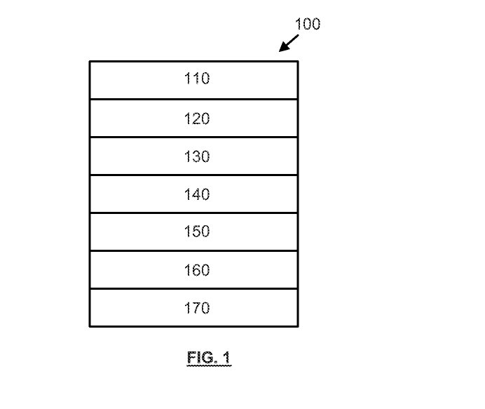

FIG. 1 shows an example of a record 100 according to an example. The record has seven fields, 110-170. Type field 110 identifies the type of record, and so gives meaning to the duration and volume information contained in the field. For example, a duration may represent server up-time, engineer response time, or a time period that is not to be considered for evaluation of performance or other duration or volume context. The type field may be an integer having a pre-assigned association with a record type, but any data type suitable for associating the record with its type may be used. Where the type field is an integer, it may be implemented as an arbitrary-precision integer, or big integer.

Start field 120 identifies the start date/time of the duration associated with the record, and may be represented by a UTC timestamp, for example. In some examples an additional field (not shown) may define a time zone (e.g. represented as an integer value) indicative of a time zone in which the Start field represents the start time, such that the value of the start time is to be offset from UTC according to the time zone field. In some examples a time zone may derived from a service entity field 160 (described below).

End field 130 identifies the end date/time of the duration, and as with the start field 120m, may be represented by a UTC timestamp. As with the start field, in some examples the time zone field may provide context for the data of the end field. In some examples a service entity field 160 may be used to offset the end field 130.

Volume field 140 represents the volume parameter and may be an integer or real value, depending on what is represented (as defined by the type field 110).

Reference field 150 identifies a particular instance of a service process that the record relates to. For example, the reference field 150 may include an incident reference number, ticket number, docket number, order number, auditable reference, etc. The reference field need not be a numerical value.

Service entity field 160 identifies the recipient of the service. For example, this may Indicate a particular piece of hardware, for example. In certain cases, this field could even be used to specify a particular component within a piece of hardware.

Field 170 may indicate when the record is to be accounted. For example, this field may include the timestamp of when the performance record is provided or the end date timestamp, whichever is the most relevant to the measurement.

In some examples a time zone field (not shown) may be used to identify a time zone in which the service entity is located.

Other record structures may be used. For example, in a business where all service providers and all service recipients are in the same time zone, the time zone field may be unnecessary. However, such considerations would ideally hold across all service processes in order to maintain a uniform record structure across all processes.

In some examples a database of standard terms and clauses may be provided. This permits SLAs to be formulated based on the established standards. The database may include a service description, linked to a measurement description, linked to both a scales of measure description (duration or volume), and a set of performance record types that are expected per the duration or volume method. The database may also include the logic for determining performance target compliance and/or quality of expectation compliance based on the record types.

In the current example, as shown in FIG. 1 the record 100 includes information representative of only one duration (represented by start and end times) and only one volume. This allows flexibility and simple aggregation of performance data across the records.

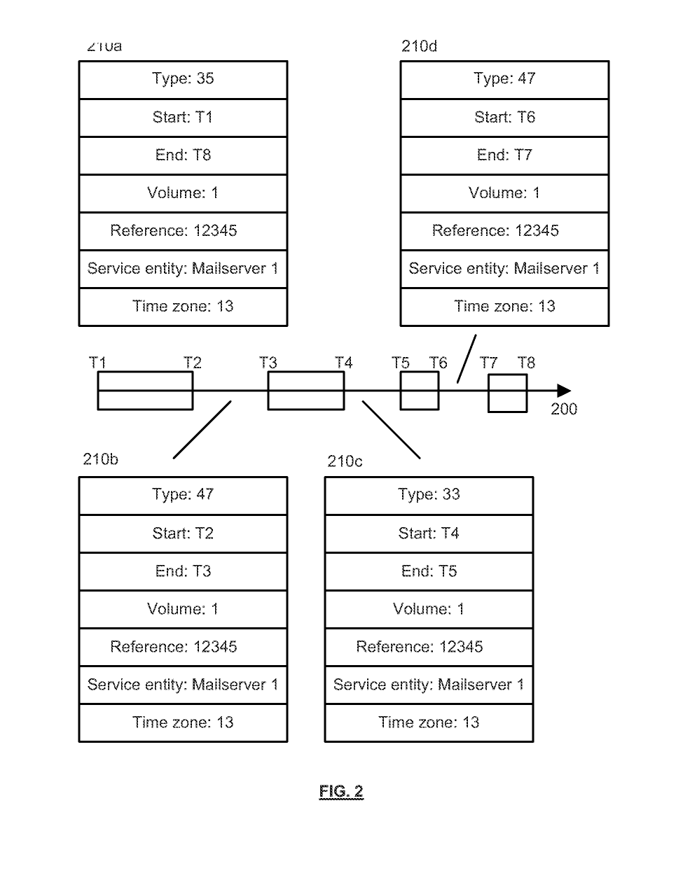

FIG. 2 shows an example of an incident timeline 200 and associated records 210a-210d. The example incident relates to server downtime, and record 210a indicates the total time from the report of the incident at time t1 to the resolution of the incident at t8. The type field identifies the record as relating to server down time. The volume field may represent how many times the server has been checked as being down in that period, and in this example is 1. The reference field may identify the server that is down, or could be an incident reference, etc. The service entity in this example is the server to which the incident relates.

Between times t2 and t3 the incident is to be suspended. This may be, for example, because an engineer is unable to gain access to the server through no fault of the service provider, and so this period is to be discarded when evaluating the performance. Record 210b indicates the duration of the suspension. Record 210b (related to a suspension of duration associated with engineer access) has a type field 110 different from that of record 210a (associated with server down-time). The volume of record 210b may be associated with a number of engineers in attendance and unable to access the site. The reference field, service entity and time zone are the same as in record 210a.

Between t3 and t4 the engineer is able to work on the server, and so this duration is relevant to the calculation of performance.

Between times t4 and t5 a power cut occurs, preventing work on the server. As this is outside the control of the service provider, the corresponding duration is not taken into account for the assessment of performance. A corresponding record 210c is generated having start and end times of t4 and t5, respectively and a type code corresponding to a power cut (i.e. a different type code to records 210a and 210b). The incident reference, service entity and time zone are the same as in records 210a and b.

Between times t5 and t6 the engineer is able to continue working, and this duration is to be taken into account when assessing performance.

Between times t6 and 17 the engineer is unable to access part of the site necessary to complete repairs, so as with time period t2 to t3, this time interval is not to be considered when assessing performance. A corresponding record 210d is generated, having start and end times of t8 and t7, respectively. The type code, volume, reference field, service entity and time zone are the same as record 210b, as these records relate to the same type of event (type code) and the other fields are unchanged.

At time t7 the engineer is able to continue working, and completes the incident (e.g. by bringing the server on line) at t8. Thus the duration t7 to t8 is to be considered for evaluating performance.

When evaluating performance, using downtime as but one example of the duration context, the duration of the downtime is represented by record 210a, but records 210b, 210c and 210d relate to time periods that are to be discounted from the duration of record 210a (Da). Accordingly, the downtime relevant for assessing performance is the duration of record 210a minus the durations of records 210b. 210c and 210d (Db, Dc and Dd):

Da−Db−Dc−Dd(T8−T1)−(T3−T2)−(T5−T4)−(T7−T6)

Thus the above arrangement permits a uniform record structure to be used to flexibly record events that occur in the course of monitoring performance (e.g. on a per incident basis in the present example one example), and to produce measure of the performance relevant to an aggregate of performance records having either a positive or negative effect. This This aggregate result (performance score) may be compared with a performance threshold (for example where a performance threshold is defined by an SLO) and it can be determined whether or not the performance score has been dealt with in conformity with the SLO. A performance clause of the SLA can then be used to determine any financial implications resulting from the performance level actually achieved.

Records 210b, 210c and 210d and the corresponding durations Db, Dc and Dd are examples of carve outs. A carve out is a duration or volume that does not contribute to evaluation of performance, and so it to be “carved out” of the duration of volume associated with a particular process or event.

In some examples, the quality of service is determined based on the records of relevant incidents, and compared with a quality of expectation. The result (e.g. compliance or non-compliance of the target) may be corresponded with a financial outcome, based on the SLA, which may prescribe a liability (or penalty) for non-compliance and/or a bonus for compliance.

In some examples the financial outcome may include contributions from one or more of fixed charges, variable charges and consequential charges. Fixed charges represent a monetary amount that is fixed (e.g. by the SLA), an example may be a service charge for providing support over a fixed period. Variable charges are charges that scale in some manner, for example with the volume of work. Examples of variable charges could be a charge per record processed, or a time during which the recipient of the service makes use of the service (e.g. computer processor time). Consequential charges are charges based on the performance of the service, and may include performance related bonuses or liabilities. Consequential charges may result from performance related to a particular incident (e.g. a penalty where a particular incident fails to me a certain performance target) or may result from an aggregation over a number of incidents (e.g. a penalty due to an expectation quality not being met, possibly as a result of a percentage of incidents failing to meet a performance target over a specified period).

The financial outcome may be represented by a monetary amount. In some examples the relevant records may be assigned contributions of the monetary amount. For example, where a bonus has been achieved, the bonus amount is divided between all records relating to compliant processes, with the amount associated with each proportional to the degree by which the performance target was exceeded. Thus, records relating to processes that exceeded the performance target by a relatively large amount are associated with relatively larger contributions than records that exceeded the performance target by a relatively small amount.

A similar process may be applied to liabilities, assigning a contribution of the liability to each record in proportion to the degree that the performance target was missed in the process associated with the respective record.

By associating contributions of the bonus or liability to the records, it can be established which processes and/or steps within a process are under-performing or over-performing against the target performance, including information on the associated monetary implications. In the case of liabilities, this information may be used to determine processes that are most in need of remedial action (e.g. causing the greatest financial loss).

Service targets can be refined or changed overtime. Some examples assist in assessing the service provider's ability to meet a target (serviceability) over all contracts, enabling evaluation of the risk associated with commitment to a particular target.

Some examples assist in the assessment of the service levels that can be achieved by each service provider (assuming a multiple supplier model), which enables the targets to be raised for competitive advantage.

In the case of bonuses, processes may be identified where higher targets could be offered to service receivers, in order to improve competitiveness against other service providers. Again, this analysis may be driven by the financial Impact of each process, so that the processes associated with the greatest financial gain may be considered as a priority.

As used herein, references to exceeding performance targets and exceeding quality of expectation means that the targets or expectation have been met or exceeded. In some cases, the performance target or quality of expectation may indicate minimum values, and in this case, the target or expectation would be exceeded (i.e. met) when the measure of the service provided is above the relevant target or expectation. In other cases, the performance target or quality of expectation may indicate maximum values, and in this case, the target or expectation would be exceeded (i.e. met) when the measure of the service provided is below the relevant target or expectation.

Thus, according to some examples the analysis not only identifies breaches or compliance per contract (effect), but provides a holistic assessment of the underlying practice (cause), or the ability to mature such practices, for much wider breach avoidance, or greater competitive advantage. Thus some examples enable holistic improvement in efficiency, limiting of liability, and achieving predictable, repeatable, and sustainable Service Levels.

By using a consistent record structure and consistent approach to the assignment of financial outcome to service processes, a like-for-like comparison of business processes may be performed between disparate business processes. Similarly, varied business processes with different key performance indicators may be grouped for comparison in a financial context of service delivery. For example, business processes may be grouped by the associated service entity, and the financial outcome associated with each service entity may be readily compared, enabling identification of over-performance or under-performance associated with specific service entities. In another example, service processes may be grouped according to responsible engineer, such that the performance of individual engineers may be assessed, and action such as rewarding or retraining may be taken as necessary. This analysis may be performed on the basis of performance data that is, in any case, collected in order to monitor compliance with performance targets and quality of expectation, and so in some cases little or no additional effort need be expended in obtaining and collating data for the analysis. In some examples a framework may be provided linking different strategic business units and resources together. This framework may use metadata outside of the performance data, but linked by process and the performance records types that each process generates.

In some examples, exceptions are applied to the records prior to determining a financial outcome. Exceptions relate to records and/or service processes that are not subject to the SLA. For example, events that are agreed as being outside the control of the service provider and that which reduce the overall duration for comparison with a performance target (e.g. the carveouts described in relation to FIG. 2). The service process and records associated with exceptions are not to be taken into account when evaluating compliance with performance targets and expectation quality, and are not associated with the financial outcome associated with performance targets and expectation quality.

In some examples an excuse process may be implemented. In some cases, a failure to meet a performance target or quality of expectation may be due to events outside the control of the service provider, such as extreme transport disruption or failure of a utility. In some examples, where service processes are determined to be associated with a liability, these may be reviewed to determine whether an excuse may apply. In some examples a database of previous excuses may be provided, and an excuse applied from the database where appropriate. Where the database does not include an appropriate precedent excuse, a new excuse may be added.

In some examples the excuse process may be applied to excuse revenue, if so agreed. For example, where a performance bonus is not due, due to an operator found to have mistakenly recorded incorrect performance data.

Where a valid excuse exists, the liability associated with the excused failure may be mitigated (e.g. reduced in part or completely).

Thus, in some examples, excuses may be used to dismiss financial liabilities (or revenues) that have been incurred. For example, if it is found that there should have been an exception but it was never processed. Thus, the after the fact excuse dismisses the liability (or revenue) on these grounds.

In some examples, the financial outcome is re-evaluated following any mitigation due to excused failures, and the re-evaluated financial outcome is used in the above-described assignment of financial outcome contribution to records or service processes. Accordingly, the assignment of financial outcomes accurately reflects the actual resultant revenue and liabilities.

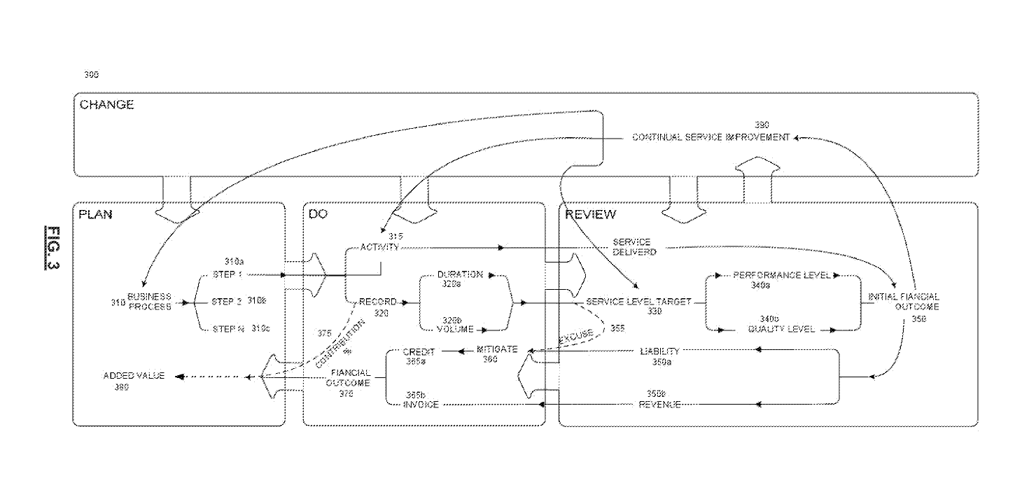

FIG. 3 shows an overview of the process 300 according to some examples. Business process 310 is developed, and consists of a number of steps or service processes 310a, 310b, 310c. In response to an incident, for example, one or more of the steps are performed, shown as activity 315, and one or more corresponding records 320 are generated describing the performance of the activity. Each record Is representative of a duration 320a and a volume 320b. The one or more records are compared with or evaluated against a service level target 330, and performance level 340a and/or quality level 340b Information is generated. This information may then be used to derive an initial financial outcome 350. The initial financial outcome may include a liability 350a and/or a revenue 350b. In the case of a liability (or revenue), one or more excuses 355 may be applied to mitigate 360 the level of liability (or revenue). In an accounting step any liability is credited 365a and any revenue invoiced 365b, resulting in a financial outcome 370 (which may be the same as the initial financial outcome 350 where no excuse is applied).

Based on the financial income 370 and the records 320, a contribution 375 may be assigned to the records (e.g. as a percentage per record of the financial outcome 370). It is to be noted that some records may receive a zero contribution, for example where the record relates to a missed target and the financial outcome is a revenue (or conversely where the record relates to an obtained target and the financial outcome is a liability). The assignment of the financial outcome to the records (or service process) may then be used to analyze 380 the business process to identify areas for improvement or change. This change may be in the form of continual service improvement 390, which may be applied to change features of the business process 310, the activity 315 or the service level target 330, for example.

Thus, the analysis may be applied, for example, to determine areas of a business process or a service process in need of improvement. The analysis may also be used to inform setting of subsequent service level targets.

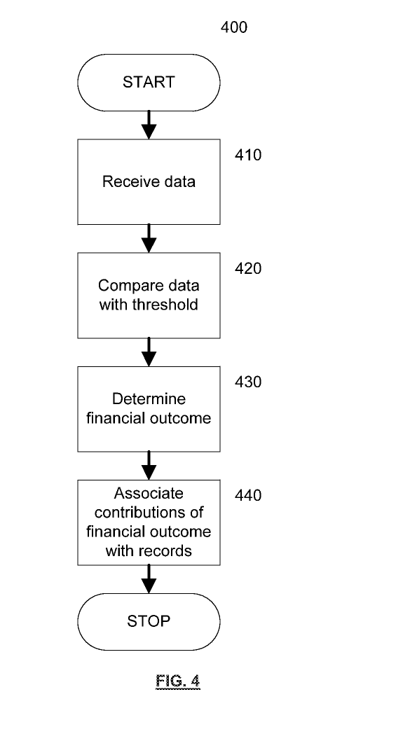

FIG. 4 shows a method 400 according to an example. A processing device is arranged to receive data 410, where the data indicates performance levels of business processes. The data includes a plurality of records associated with one or more business processes. Each record includes performance data. In 420 the received data is compared with a threshold derived from the service contract. At 430 a financial outcome is determined based, at least in part on the result of the comparison in 420. In 440, the financial outcome is associated with the records based on the result of the comparison in 420. The association may be as described above, for example.

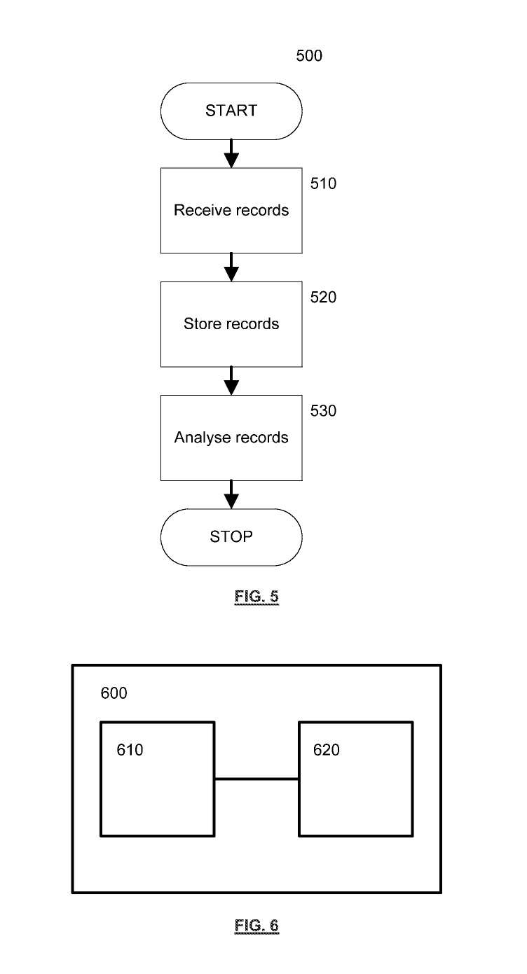

FIG. 5 shows a method 500 according to an example. At 510 a plurality of records indicating performance levels of respective business processes is received. The records are stored, for example in a database, at 520. At 530 the records are analyzed. The records may be as described above. For example, each record may include performance data elements representative only of a single duration and a single volume.

Accordingly, some examples provide a simple technique for the production of service level management balanced score cards, exposing actual and expected performance scores, quality scores, financial outcomes and service improvements. The apportionment of financial outcome to performance record may be depicted on balanced score cards, enabling individual mitigation of liabilities. Some examples may holistically expose the overall financial value of each business/technical process, service, service provider, geographic region, strategic business unit, or other related data dimension, regardless of how many service level agreements, operating level agreements and underpinning contracts have been satisfied or are in force. Some examples may historically monitor and expose the level of service a service provider has or is expected to achieve overall, regardless of how many service level agreements, operating level agreements and underpinning contracts they have satisfied.

Some examples may enable the production of periodic financial statements of incurred revenue and/or liability per agreement, or other data dimension, whether fixed, compound, consumption or performance based. Some examples may identify where current contractual expectations are not being met in advance of any period end, so that action can be taken for the avoidance of liabilities. Some examples may ensure that the geographic location of service provision is factored in to any assessment of what does or does not fall within service times, appropriately ignoring liabilities falling outside of such times.

In some examples, any chronically failing or unserviceable service entity is placed in a quarantine following a consensus agreement, so that it may be excluded from incurring further liabilities unduly.

Some examples may simplify the addition or removal of service entities to or from a service agreement, based on its service classification or service grouping, while still allowing individual service entities to be expressly included or excluded.

In some examples the location of any service entity is accounted for so as to acquire a time zone context, prior to assessment of performance and durations falling within service times. Some examples ensure the removal from any duration measurement, any time which is considered outside of service times (carve out). For example, public holidays and periods of noted service exceptions such as force majeure may be excluded using carve outs. Thus only the agreed service times are accounted and compensated accordingly. Similarly, in some examples any Volume measurement occurring outside of service times may be removed (carved out). In some examples this occurs where a maximum volume measurement is encountered.

Some examples use a fixed number of fields for reporting volume and/or duration performance data, which is the basis for performance, quality or financial assessment.

Some examples use a fixed number of fields for collecting performance data attributes, which are used to trigger a service delivery lifecycle with future performance expectations.

Some examples ensure that any changes to a contract are effective over time, using a chronological activation point within the timeline, to either invoke or remove a change. This then avoids the needs to continually revisit or revision the contract, whereby change is thereafter automated over time.

In some examples reports and alerts may be automatically communicated to an individual or group of individuals, based on whether a service level threshold or financial threshold is met or breached. The individual or group of individuals may depend on the service level threshold or financial threshold in question. In some examples reports are produced automatically that describe the contents of each service, agreement, measurement, performance data or other retained meta data.

In some examples, breaches of contract to be excused, discounting either in full or part, any liability that may be due. Some examples allow prioritization of liabilities for mitigation, in order of greatest financial loss first, exposing each related and failing performance record, with their apportionment of liability. In some examples best case and worst case service levels may be determined holistically per measurement, and any improvement or degradation period on period may also be determined. In some examples each performance record may be classified as a performance record type, so that the value of each business or technical process (based on its performance record type), can be exposed holistically.

In some examples related performance data may be automatically aggregated before assessment, to ensure that any service exceptions (e.g. represented by negative performance data) are identified and removed before performance assessment. In some examples service level targets may be adjusted using the performance data, where service level targets need to be adjusted outside the constraints of a service agreement. In some examples service level targets may be aligned where they need to be based on service time elapsing within a specified period (e.g. within a calendar month). For example when the target is linked to service time.

In some examples financial outcomes may be adjusted based on weighting factors that identify the criticality of the service receivers infrastructure or commercial functions. In some examples financial outcomes may be derived at the end of a period, on performance achievement or breach, or on quality achievement or breach. This includes parameterized input, enabling the reuse of financial calculations at each of these levels.

Examples may be used to assess Service level agreements, operating level agreements and underpinning contracts. Moreover, the effect of one agreement on another may be assessed, especially where operating level agreements or under pinning contracts support, in whole or part, any part of a service level agreement.

In some examples, the system and methods described herein may be implemented using a processing device such as a computer. An example of a suitable processing device is shown in FIG. 6. The processing device 600 of FIG. 6 includes a memory 610 for storing instructions, and a processor 620 for performing the instructions stored by the memory. The processing device may include other components, such as a storage section for storing data. The storage section may be embodied by a hard drive or similar device.

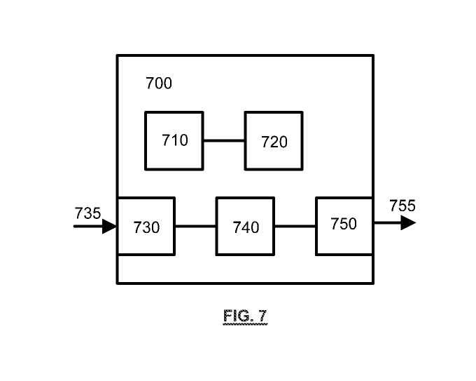

FIG. 7 shows an example of a processing device suitable for implementing examples described herein. Processing system 700 includes a memory 710 and a processor 720. The processor 720 executes instructions stored by the memory 710. The processor 720 causes the system 700 to operate as an input section 730 to receive records 735. The input section may include a keyboard, data connection, etc. Each of the records may be a record as described herein. For example, each record may include performance data elements representative only of a single duration and a single volume. The processor 720 further causes the system 700 to operate as a database 740 in which the received records are to be stored. The processor 720 may also cause the system 700 to operate as an analysis section 750 to query the records and perform analysis thereon. The analysis may include deriving a financial outcome and assigning contributions of the financial outcome to the records, as described herein. A result of the analysis may be provided as output 755.

In some examples, a storage medium may be provided, the storage medium be a non-transient computer-readable storage medium having stored thereon computer-readable instructions that, when executed by a processing device, cause the processing device to perform a method or operate as a device or system described herein.

Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect or example of the invention are to be understood to be applicable to any other aspect or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing examples.

1. A device to perform service contract analysis, the device comprising:
a processor, and
a memory, wherein the memory comprises instructions, the processor to perform the instructions to cause the device to operate to:
receive data indicating performance levels of business processes subject to a service contract, the data including a plurality of records, each record including performance data, and each record associated with a business process;
compare the performance data with a threshold derived from the service contract;
determine a financial outcome based on the comparing; and
associate contributions of the financial outcome with respective records or respective service processes, wherein the contributions are based on the comparing.

2. The device of claim 1, wherein the device is further to identify a business process or a step of a business process that is in need of improvement, based on the associating.

3. The device of claim 1, wherein the device is further to identify a business process or step of a business process that over-performed based on the associating.

4. The device of claim 1, wherein each of the plurality of records has an identical field structure.

5. The device of claim 1, wherein each record includes performance data elements representative only of a single duration and a single volume.

6. The device of claim 1, wherein the financial outcome is a liability or a revenue.

7. The device of claim 1, wherein the device is further to receive excuse information, the excuse information identifying a record, wherein the record identified by the excuse information is omitted in at least one of the determining and associating.

8. The device of claim 1, wherein the financial outcome includes at least one of a fixed service charge, a variable service charge and a consequential service charge.

9. The device of claim 1, wherein at least one of the records is a carve out record that represents a carve out corresponding to an event that is not to be factored against a performance target, the record offsetting a duration and/or volume of a related record that is to be factored against the performance target.

10. A processing system to perform service contract analysis, the system comprising:
a processor; and
a memory, wherein the memory comprises instructions, the processor to perform the instructions to cause the system to operate as;
an input section to receive a plurality of records to indicate performance levels of respective business processes;
a database section to store the plurality of records; and
an analysis section to query the plurality of records, wherein
each record includes performance data elements representative only of a single duration and a single volume.

11. The system of claim 10, wherein each record further includes a record type identifier field, the record type identifier field to define the meaning of the performance data elements.

12. The system of claim 10, wherein the analysis section is to determine a financial outcome based on the performance data elements, and to automatically associate contributions of the financial outcome to the records based on the performance data elements.

13. A non-transient computer readable storage medium having stored thereon computer readable instructions to cause a processing device to:
receive data indicating performance levels of business processes subject to a service contract, the data including a plurality of records, each record including performance data, and each record associated with a business process;
compare the performance data with a threshold derived from the service contract;
determine a financial outcome based on the comparing; and
associate contributions of the financial outcome with respective records or respective service processes, wherein the contributions are based on the comparing.
